(19) United States
(12) Patent Application Publication
(10) Pub. No.: US 2010/0161758 A1
(43) Pub. Date: Jun. 24, 2010

(54) METHOD AND APPARATUS FOR ENABLING CONTENT SHARING AMONG ENDPOINT DEVICES

(76) Inventors: Mostafa Tofigh, Cupertino, CA (US); David Wolter, Austin, TX (US)

Correspondence Address: AT & T LEGAL DEPARTMENT - WT, PATENT DOCKETING, ROOM 2A-207, ONE AT& T WAY, BEDMINSTER, NJ, 07921, US

(21) Appl. No.: 12/341,907

(22) Filed: Dec. 22, 2008

(51) Int. Cl. G06F 15/16

(52) U.S. Cl. 709/218

(57) ABSTRACT

A method and apparatus for enabling content sharing among endpoint devices over a network. For example, the method creates a new content or an updated content, and stores the new content or the updated content in at least one memory location of a mobile endpoint device accessible by one or more groups. The method sends a notification of the storing of the new content or the updated content to at least one member of the one or more groups.

The present invention relates generally to communication networks and, more particularly, to a method and apparatus for providing content sharing among endpoint devices over a network, e.g., a cellular network, an Internet Protocol (IP) network, and the like.

### BACKGROUND OF THE INVENTION

A customer may wish to share a content located in an endpoint device (e.g., an IP phone) with one or more users. For example, a customer may store a multimedia content in a cell phone and may wish to share the content with a predetermined list of friends, family, co-workers, etc. The customer may then transmit a copy of the multimedia content to each user via a wireless network. For example, the customer may email the multimedia content to each user. However, transmitting the content to each user's endpoint device may consume a large percentage of the bandwidth of the wireless network.

### SUMMARY OF THE INVENTION

In one embodiment, the present invention discloses a method and apparatus for enabling content sharing among endpoint devices over a network. For example, the method creates a new content or an updated content, and stores the new content or the updated content in at least one memory location of a mobile endpoint device accessible by one or more groups. The method sends a notification of the storing of the new content or the updated content to at least one member of the one or more groups.

### BRIEF DESCRIPTION OF THE DRAWINGS

The teaching of the present invention can be readily understood by considering the following detailed description in conjunction with the accompanying drawings, in which:

FIG. 1 illustrates an exemplary network related to the present invention;

FIG. 2 illustrates an exemplary network of the current invention for providing content sharing among endpoint devices;

FIG. 3 illustrates a flowchart of an exemplary method for providing content sharing among endpoint devices over a network; and

FIG. 4 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present invention broadly discloses a method and apparatus for enabling content sharing among endpoint devices over a network. Although the present invention is discussed below in the context of sharing content (e.g., data, multimedia, etc.) over a cellular network, the present invention is not so limited. Namely, the present invention can be applied to other types of networks, e.g., a wireless local access network, an Internet Protocol (IP) network and the like.

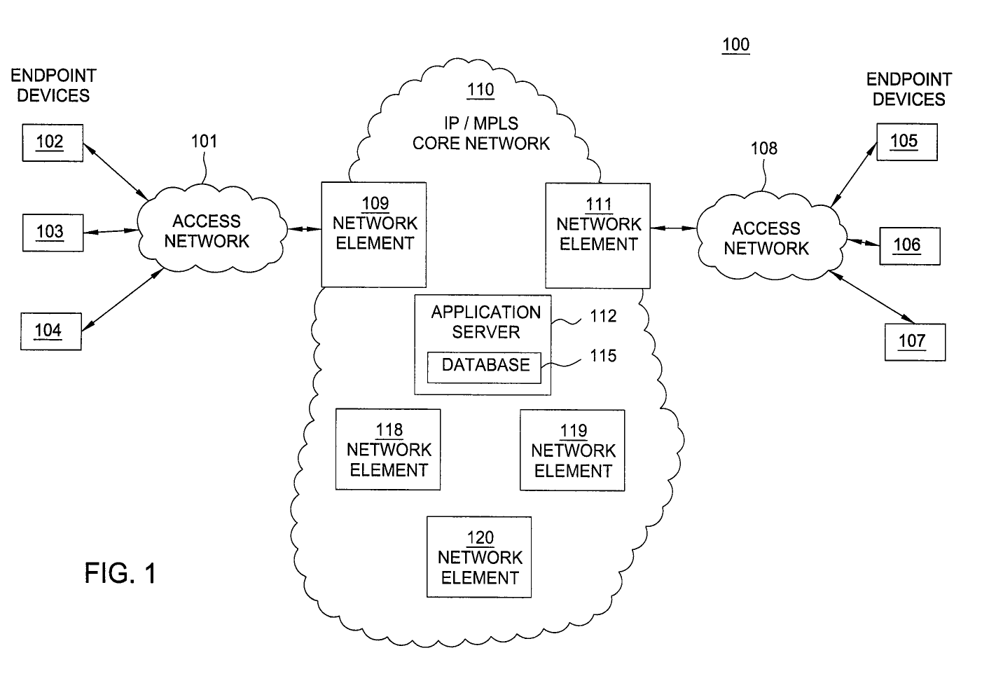

FIG. 1 is a block diagram depicting an exemplary packet network 100 related to the current invention. Exemplary packet networks include Internet protocol (IP) networks, Ethernet networks, and the like. An IP network is broadly defined as a network that uses Internet Protocol such as IPv4 or lPv6 and the like, to exchange data packets.

In one embodiment, the packet network may comprise a plurality of endpoint devices 102-104 configured for communication with the core packet network 110 (e.g., an IP based core backbone network supported by a service provider) via an access network 101. Similarly, a plurality of endpoint devices 105-107 are configured for communication with the core packet network 110 via an access network 108. The network elements (NEs) 109 and 111 may serve as gateway servers or edge routers for the network 110.

The endpoint devices 102-107 may comprise customer endpoint devices such as smart IP phones, Personal Digital Assistants (PDAs), analog phones, and the like. The access networks 101 and 108 serve as a means to establish a connection between the endpoint devices 102-107 and the NEs 109 and 1 1 1 of the IP/MPLS core network 1 10. The access networks 101 and 108 may each comprise a Digital Subscriber Line (DSL) network, a broadband cable access network, a Local Area Network (LAN), a Wireless Access Network (WAN), a 3^{rd} party network, and the like. The access networks 101 and 108 may be either directly connected to NEs 109 and 111 of the IP/MPLS core network 110, or indirectly through another network.

Some NEs (e.g., NEs 109 and 111 ) reside at the edge of the core infrastructure and interface with customer endpoints over various types of access networks. An NE that resides at the edge of a core infrastructure is typically implemented as an edge router, a media gateway, a border element, a firewall, a switch, and the like. An NE may also reside within the network (e.g., NEs 118-120) and may be used as a mail server, a core router, or like device. The IP/MPLS core network 110 also comprises an application server 112 that contains a database 115. The application server 112 may comprise any server or computer that is well known in the art, and the database 115 may be any type of electronic collection of data that is also well known in the art. It is noted that although only six endpoint devices, two access networks, five network elements, one application server and so on are depicted in FIG. 1, the communication network 100 may be expanded by including additional endpoint devices, access networks, network elements, and/or application servers, without altering the scope of the present invention. The above IP network is described to provide an illustrative environment in which packets for various services, e.g., for voice, data, and multimedia services, are transmitted on networks.

In one embodiment, a customer may wish to share a content located in an endpoint device of the customer (e.g., an IP phone) with one or more users. For example, a customer may have stored multimedia content in a cell phone and may wish to share the multimedia content with a predetermined list of individuals such as friends, family, co-workers, etc. The customer may then send a copy of the multimedia content to each user via email. For example, the customer may use the cell phone to send an email with the multimedia content being contained as an attachment to the email. However, transmitting the content to each of the multiple user endpoint devices (e.g., user cell phones, PDAs, and the like) consumes the bandwidth of the wireless network. Furthermore, a user may receive at least some content that he/she is not interested in receiving.

In one embodiment, the current invention provides content sharing among multiple endpoint devices over a network. The method first enables a customer to allocate a memory location in an endpoint device (e.g., an IP phone, a cell phone and the like) for sharing content among a group of users. For example, a customer may allocate a memory location on his/her IP phone for sharing content (e.g., multimedia content, photos, files, etc.) among a group of users (e.g., friends, family, coworkers, etc.).

In one embodiment, the customer may establish one or more groups of users, wherein each group has a membership list and access criteria. For example, the customer may establish a membership list for each group and provide a pre-determined method for accessing the content by members of each of the groups. In one example, the customer may have a first group for friends and family, and a second group for coworkers. The customer may then establish a membership list for each of the two groups. Members of a group may be given a password for authenticating their identity, and a Universal Resource Locator (URL) for locating the content. The method allows members of the first group (e.g., friends and family) to only access content the customer specifies as being accessible to the first group. Similar, members of the second group (e.g., coworkers) may only access content intended for the second group.

To illustrate, the method may create a new content and/or perform an update to a previous or existing content. For example, the method may capture new content for sharing with members of one or more groups via a camera on an IP phone or a cellular phone. For example, the customer using an endpoint device may take photos and/or videos that can then be shared with members of one or more groups.

In one embodiment, the method stores the new content and/or the update of previous content in a memory location accessible by one or more groups. For example, the method may store captured photos in a memory location accessible by family and friends, or by coworkers. For example, the customer may place photos from a family vacation in a memory location accessible by friends and family, while placing photos from a work related event in a location accessible by coworkers.

In one embodiment, the method sends a notification to members of the one or more groups. For the above example, if the customer captures new photos and stores the photos in the location accessible by members of the first group (e.g., friends and family), the method sends a notification to the friends and family who are members of the first group.

In one embodiment, the members may then access an index updated with the newly stored content. For example, the above URL may be used to access an index and/or metadata of the stored content. The member may then use the index and/or metadata for selecting all or only a desired portion of the stored content. The member may then retrieve the desired content (if any) and copy the desired content to the member's own endpoint device. For the example above, a member may review the index and/or metadata of the stored content and copy the desired photos to his/her own IP phone. In another example, a member may review the content of the index and/or metadata, and decide that the entire content is undesirable.

It should be noted that the index and/or metadata can be implemented in a variety of different formats. For example, the index and/or metadata may comprise an alphanumeric code, a text string, a small thumbnail image representative of a picture or a video, an audio message (e.g., “picture of birthday party”), and the like. It should be noted that the present invention is not limited to any particular index or metadata format.

In one embodiment, the method receives a request for providing a desired content from a member of the group. For example, after sending a notification of newly stored content to members of the group, the method may receive from one or more members of the group a request for sending the newly stored content. For the example above, a family member who received a notification of newly stored photos may send a request to the customer to send a copy of the photos. The method may then provide the desired content (requested content) to the member of the group from whom the request is received, in accordance with the received request.

In one embodiment, the service provider is tasked with the tracking of the receipt of the notification that has been sent to the members of each group. For example, if a notification is sent to all 10 members of a group, but one or more members of the group may have their endpoint devices powered-off, or they are outside of a service range, and the like, then it is possible that one or more members of the group would have failed to receive the notification. In one embodiment, the service provider will track those notifications that were not received by members of the group (broadly notification failures), where the service provider will attempt to resend the notification to such members at a later time. Alternatively, the service provider may provide feedback to the user device to indicate that there were a number of notification failures, thereby alerting the user that one or more members of the group may not have received the notification.

In one embodiment, the member of the group may retrieve the desired content directly. For example, the member may use his/her IP phone to access the location of the stored content in the customer's IP phone and retrieve the desired content directly without the assistance of the customer. In one embodiment, the member may access the desired content via a background process. For example, when the member establishes a communication session with the customer's mobile endpoint device, there is no need for the customer to interact with the member. The customer's mobile endpoint device my simply provide an alert (e.g., an audio signal (a beeping sound), a tactile signal (a vibration), and/or a visual signal (a message displayed on a screen of the cellular phone)) so that the customer is alerted that a communication session has been established and is on-going with the customer's mobile endpoint device.

For the example above, a member of the first group (e.g., a family or a friend), may access the location designated by the customer for the first group, provide authentication, and retrieve the desired photos from the customer's IP phone. That is, the member may obtain the photos directly without requiring an action (e.g., sending the photos) by the customer.

In one embodiment, the method may send the index and/or metadata to members of a group. For example, the method may send the index and/or metadata instead or in conjunction with the notification. Namely, the notification in and of itself, only enables a member to determine that an updated index is available but it does not enable the member to determine the actual update. Thus, for some applications it may be beneficial to send the updated index and/or metadata along with the notification to members of a group which will allow the members to easily determine what content has been added or updated.

In one embodiment, the method enables a plurality of groups to access a stored content. For example, the customer may wish to enable members of multiple groups to access the same content. For the example above, the customer may wish members of both the first group (family and friends) and the second group (coworkers) to access a stored content. The members of each group may then use their respective methods of authentication to access and retrieve the same content.

In one embodiment, the method enables a user to be a member of multiple groups. For example, a customer may establish a membership list for groups but the membership lists may overlap. For example, if a first group is for family and friends and a second group is for coworkers, there may be some members who may be a coworker and a family member, a coworker and a friend, and so on. Thus, the customer may establish a membership list with some members belonging to two or more groups.

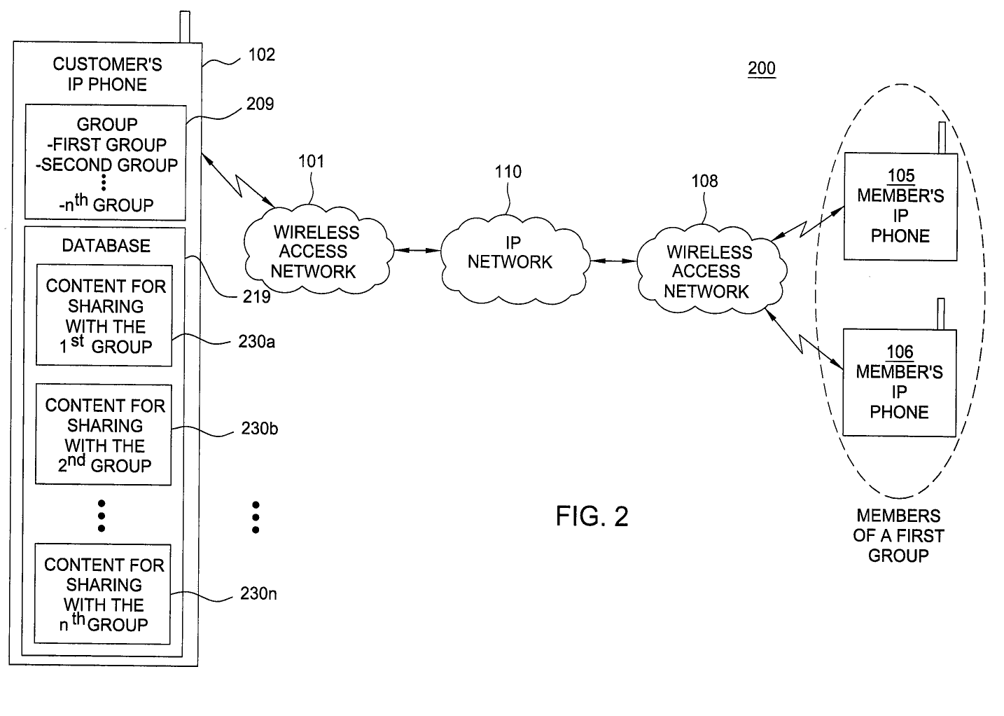

FIG. 2 illustrates an exemplary network 200 with the current invention for enabling content sharing among endpoint devices, e.g., IP endpoint devices. The exemplary network 200 comprises an IP endpoint device 102 communicating with an IP network 110 via a wireless access network 101. Similarly, IP endpoint devices 105 and 106 are communicating with the IP network 110 via wireless access network 108.

It should be noted that the wireless access networks 101 and 108 may comprise any type of wireless networks, e.g., 2G, 3G or 4G cellular networks, Wi-Fi or WiMAX network, and the like. Broadly defined, Wi-Fi is a wireless local area network (WLAN) technology, e.g., based on the Institute of Electrical & Electronics Engineers (IEEE) 802.11 standards. WiMAX is a wireless metropolitan area network (MAN) technology, e.g., based on the Institute of Electrical & Electronics Engineers (IEEE) 802.16 standards. 2G is the second generation cellular network technology while 3G is the third generation cellular network technology, and 4G is the fourth generation cellular network technology.

In one embodiment, a customer may use IP endpoint device 102 to share content with users of the IP endpoint devices 105 and 106. For example, the customer's IP phone 102 may comprise a memory module or a storage module (e.g., memory chips, flash memory chips, and the like) that is configured to store a set of groups 209 and a database 219. The database 219 comprises a plurality of memory or storage locations 230a-230n for storing content for sharing with a plurality of groups. It should be noted that memory or storage locations 230a-230n may not be physically distinct memory locations, but instead, may comprise distinct logical memory locations.

In one embodiment, the customer establishes a membership list for each of the plurality of groups. For example, the customer may establish a membership list for a first group (e.g., friends and family), a second group (e.g., coworkers), and so on. Content intended to be shared with members of the first group can be stored in memory location 230a. Similarly, content intended to be shared with members of the second group can be stored in memory location 230b.

In one embodiment, when a new or updated content is stored by the customer in a specific location (e.g., memory location 230a), the method notifies members of the group who are authorized to access the memory location 230a (e.g., members of the first group) that an updated or new content is stored. For example, the members of the first group with IP phones 105 and 106 may receive a notification of the newly stored content. Each of the members of the first group may then select and obtain a desired portion of the newly stored content by accessing an index and/or metadata of the content.

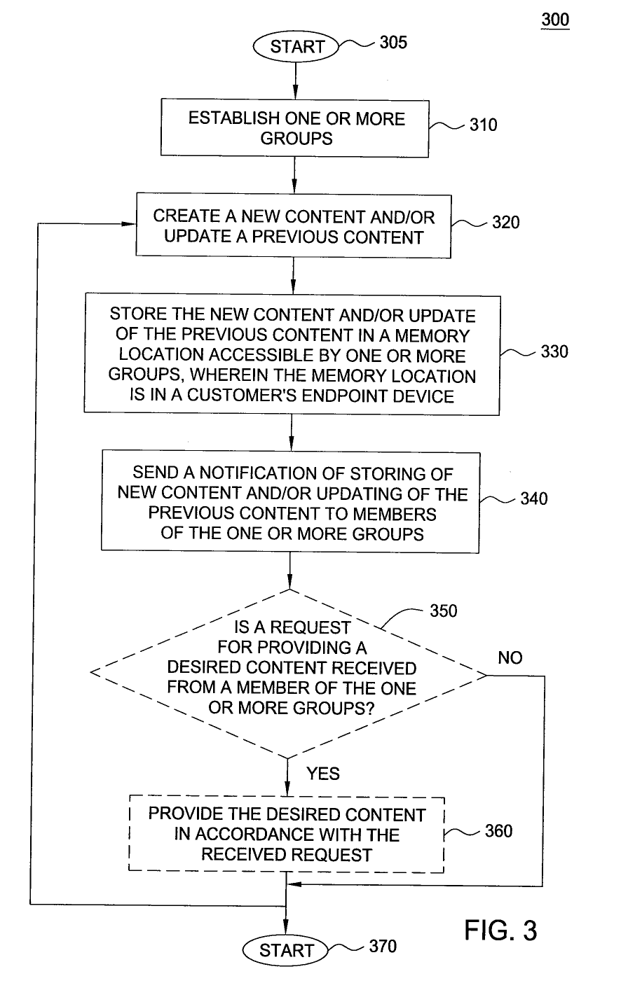

FIG. 3 illustrates a flowchart of a method 300 for providing content sharing among endpoint devices over a network. For example, one or more steps of method 300 can be implemented by a mobile endpoint device. Method 300 starts in step 305 and proceeds to step 310.

In step 310, method 300 establishes one or more groups, wherein each group has a membership list and predefined access criteria. For example, the customer may establish a membership list for a plurality of groups and provide access criteria (e.g., a pre-determined URL, password, etc.) for enabling members of the group to access content stored at a memory location of the customer's mobile endpoint device.

In step 320, method 300 creates a new content and/or updates a previous content (broadly defined as updated content). For example, the method may capture new content (e.g., a picture, a video and the like) via a camera (broadly referred to as a content generator) in the customer's mobile endpoint device for sharing with members of a group. For example, the customer may take photos for sharing with members of one or more groups. In another example, the method may update a previously stored content (e.g., updating a document, a video, a photo, etc.)

In step 330, method 300 stores the new content and/or updates the previous content in a memory location of a storage device that is accessible by one or more groups, wherein the memory location is in a customer's mobile endpoint device. For example, the method may store captured photos in a memory location accessible by family and friends, wherein the memory location is in the customer's cell phone.

In step 340, method 300 sends (e.g., via a transceiver) a notification of the storing of new content and/or the update of previous content to members of the one or more groups. For example, if new photos are stored at a memory location accessible by members of a first group (e.g., family and friends), the notification of newly stored content may by sent to members of the first group.

In optional step 350, method 300 determines if a request for providing a desired content is received from a member of the one or more groups. For the example above, after sending a notification of newly stored content to members of the one or more groups, the method may receive from a member of at least one of the groups a request for sending the newly stored content. If a request for providing the desired content is received, the method proceeds to step 360. Otherwise, the method ends in step 370 or returns to step 320 to continue creating or updating more content.

In optional step 360, method 300 provides the desired content (requested content) to the member of the group from whom the request is received in accordance with the received request. The method ends in step 370 or returns to step 320 to continue creating or updating more content.

It should be noted that although not specifically specified, one or more steps of method 300 may include a storing, displaying and/or outputting step as required for a particular application. In other words, any data, records, fields, and/or intermediate results discussed in the method 300 can be stored, displayed and/or outputted to another device as required for a particular application. Furthermore, steps or blocks in FIG. 3 that recite a determining operation, or involve a decision, do not necessarily require that both branches of the determining operation be practiced. In other words, one of the branches of the determining operation can be deemed as an optional step.

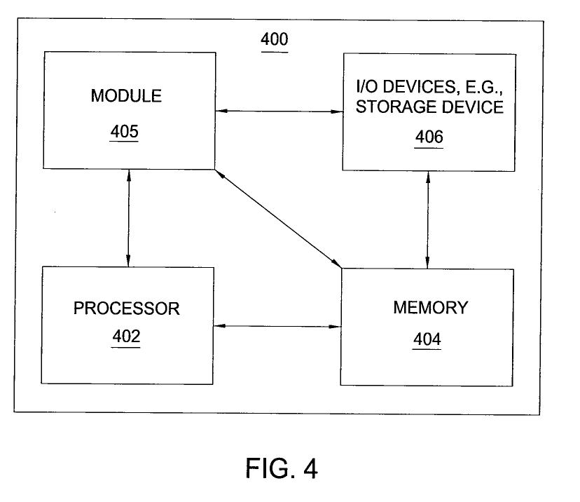

FIG. 4 depicts a high-level block diagram of a general-purpose computing or communication device (e.g., a mobile endpoint device) suitable for use in performing the functions described herein. As depicted in FIG. 4, the system 400 comprises a processor element 402 (e.g., a CPU), a memory 404, e.g., random access memory (RAM) and/or read only memory (ROM), a module 405 for providing content sharing among endpoint devices over a network, and a plurality of input/output devices 406 (e.g., one or more of storage devices (including but not limited to, a tape drive, a floppy drive, a hard disk drive or a compact disk drive), a receiver, a transmitter, a transceiver, an antenna, a speaker, a display, a speech synthesizer, an image or video capturing module, a camera, a content generator, an output port, an input port, and a user input device (such as a keyboard, a keypad, a mouse, a touch screen, and the like)).

It should be noted that the present invention can be implemented in software and/or in a combination of software and hardware, e.g., using application specific integrated circuits (ASIC), a general purpose computer or any other hardware equivalents. In one embodiment, the present module or process 405 for providing content sharing among endpoint devices over a network can be loaded into memory 404 and executed by processor 402 to implement the functions as discussed above. As such, the present method 405 for providing content sharing among endpoint devices over a network (including associated data structures) of the present invention can be stored on a computer readable medium, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for sharing content over a network, comprising:
creating a new content or an updated content;
storing said new content or said updated content in at least one memory location of a mobile endpoint device accessible by one or more groups; and
sending a notification of said storing of said new content or said updated content to at least one member of said one or more groups.

2. The method of claim 1, further comprising:
receiving a request for at least a portion of said new content or said updated content from said at least one member; and
providing said portion of said new content or said updated content to said at least one member in accordance with said request.

3. The method of claim 1, wherein each of said one or more groups comprises a membership list and at least one access criterion.

4. The method of claim 1, wherein said at least one member retrieves at least a portion of said new content or said updated content directly from said mobile endpoint device.

5. The method of claim 1, further comprising:
sending an index or metadata associated with said new content or said updated content to said at least one member of said one or more groups.

6. The method of claim 1, wherein said at least one memory location comprises a plurality of memory locations, where each of said plurality of memory locations is associated with one of said one or more groups.

7. The method of claim 1, wherein said network comprises a wireless network.

8. The method of claim 7, wherein said wireless network comprises at least one of: a 2G cellular network, a 3G cellular network, a 4G cellular network, a Wi-Fi network or a WiMAX network.

9. A computer-readable medium having stored thereon a plurality of instructions, the plurality of instructions including instructions which, when executed by a processor, cause the processor to perform steps of a method for sharing content over a network, comprising:
creating a new content or an updated content;
storing said new content or said updated content in at least one memory location of a mobile endpoint device accessible by one or more groups; and
sending a notification of said storing of said new content or said updated content to at least one member of said one or more groups.

10. The computer-readable medium of claim 9, further comprising:
receiving a request for at least a portion of said new content or said updated content from said at least one member; and
providing said portion of said new content or said updated content to said at least one member in accordance with said request.

11. The computer-readable medium of claim 9, wherein each of said one or more groups comprises a membership list and at least one access criterion.

12. The computer-readable medium of claim 9, wherein said at least one member retrieves at least a portion of said new content or said updated content directly from said mobile endpoint device.

13. The computer-readable medium of claim 9, further comprising:
sending an index or metadata associated with said new content or said updated content to said at least one member of said one or more groups.

14. The computer-readable medium of claim 9, wherein said at least one memory location comprises a plurality of memory locations, where each of said plurality of memory locations is associated with one of said one or more groups.

15. The computer-readable medium of claim 9, wherein said network comprises a wireless network.

16. The computer-readable medium of claim 15, wherein said wireless network comprises at least one of: a 2G cellular network, a 3G cellular network, a 4G cellular network, a Wi-Fi network or a WiMAX network.

17. A mobile endpoint device for sharing content over a network, comprising:
a content generator for creating a new content or an updated content;
a storage device for storing said new content or said updated content in at least one memory location of the mobile endpoint device accessible by one or more groups; and
a transceiver, in communication with said storage device, for sending a notification of said storing of said new content or said updated content to at least one member of said one or more groups.

18. The mobile endpoint device of claim 17, wherein said transceiver receives a request for at least a portion of said new content or said updated content from said at least one member, and provides said portion of said new content or said updated content to said at least one member in accordance with said request.

19. The mobile endpoint device of claim 17, wherein each of said one or more groups comprises a membership list and at least one access criterion.

20. The mobile endpoint device of claim 17, wherein said at least one member retrieves at least a portion of said new content or said updated content directly from said mobile endpoint device.
